(19) United States
(12) Patent Application Publication
(10) Pub. No.: US 2021/0110478 A1
(43) Pub. Date: Apr. 15, 2021

(54) SYSTEM AND METHOD FOR GENERATING AND DISPLAYING INVESTMENT ANALYTICS

(71) Applicant: Catherine Irene SHANNON, Minnetrista, MN (US)

(72) Inventor: Catherine Irene SHANNON, Minnetrista, MN (US)

(21) Appl. No.: 17/066,449

(22) Filed: Oct. 8, 2020

Related U.S. Application Data
(60) Provisional application No. 62/913,039, filed on Oct. 9, 2019.

(51) Int. Cl. G06Q 40/06; G06F 16/904; G06T 11/20

(52) U.S. Cl. CPC G06Q 40/06; G06T 11/206; G06F 16/904

(57) ABSTRACT

The present disclosure relates to novel and advantageous systems and methods for aiding consumers, including individual investors, fiduciaries, and other financial industry professionals, in making investment decisions. In particular, the present disclosure relates to novel and advantageous systems and methods for generating and displaying investment analytics by analyzing raw data such as investment metrics and displaying them in an easy-to-understand format. This allows an investor to make decisions based on a plurality of relevant metrics.

### FIELD OF THE INVENTION

The present disclosure relates to novel and advantageous systems and methods for aiding consumers in making investment decisions. In particular, the present disclosure relates to novel and advantageous systems and methods for generating and displaying investment analytics by analyzing raw data such as investment metrics and displaying them in an easy-to-understand format. This allows an investor to make decisions based on a plurality of relevant metrics.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

There are several metrics that are important for analyzing the performance of an investment fund or an investment fund manager. These may include, for example, (1) risk/return metrics, (2) up/down capture ratios, (3) multi-year data trends vs. a benchmark, and (4) fund performance vs. a peer group. While data in these metrics are available, it is very difficult for an individual to knowledgeably and confidently compare the metrics. Most investors lack the skill and knowledge of advanced comparative data analytics necessary to understand and successfully evaluate the significance of performance in each of these metrics. Further, even with the understanding and knowledge to evaluate the performance of each of the metrics, a comprehensive analysis is generally subjective and extremely time consuming to complete. As a result, individuals commonly make uninformed selections based nearly exclusively on posted returns.

Thus, there is a need in the art for generating investment analytics and presenting the investment analytics to an individual in a manner to allow them to make an informed investment decision or to make suitable investment recommendations to consumers (if an investment manager or financial advisor).

### SUMMARY OF THE INVENTION

The present disclosure relates to novel and advantageous systems and methods for aiding consumers in making investment decisions. In particular, the present disclosure relates to novel and advantageous systems and methods for generating investment analytics by analyzing raw data such as investment metrics and displaying or modeling the investment analytics in an easy-to-understand format. This allows an investor to make a decision based on a multitude of relevant metrics rather than based purely on returns. The systems and methods described herein may be useful to a wide range of individuals. For example, licensed financial advisors or registered investment advisors may use the systems and methods provided herein to advise their clients. The systems and methods described herein can be used by financial advisors or other investment fiduciaries to inform recommendations and guidance to consumers. Financial analysts or those who staff a firm's Chief Investment Office may use the systems and methods provided herein to provide fund manager selection, oversight, and guidance to their financial advisor sales force. Investment fund managers or portfolio managers may use the systems and methods provided herein to inform their stock or other investment selections pursuant to the investment funds or investment portfolios they manage. Additionally, the systems and methods described herein may be useful to Corporations and Foundations to help guide their analysts' decisions about how to invest corporate or foundation assets.

In one embodiment, a method for generating and displaying analytics is provided. The method may include establishing a group of datasets and gathering data points relating to performance of each dataset. The method may further include assigning a value to each data point and ranking overall performance of each dataset based on the value of each data point. In some embodiments, assigning a value may be based on the relative value of each data point. The method may then include presenting ranking of the datasets in an easily-understandable format.

In another embodiment a computer-readable storage medium containing instructions for a method for generating and displaying analytics is provided. Execution of the program instructions by one or more processors of a computer system causes the one or more processors to perform steps including establishing a group of datasets; gathering data points relating to performance of each dataset; assigning a value to each data point; ranking overall performance of each dataset based on the value of each data point; and presenting ranking of the datasets in an easily-understandable format. In some embodiments, ranking overall performance of each dataset may be based on the aggregated relative value of each data point.

In yet a further embodiment, a system for generating and displaying analytics is provided. The system may include a dataset module for establishing a group of datasets and an extraction module for gathering data points relating to performance of each dataset. The system may further include a valuation module for assigning a value to each data point and a ranking module ranking overall performance of each dataset based on the value of each data point. The system may include a display module for presenting ranking of the datasets in an easily-understandable format.

Other aspects and advantages of the present invention will become apparent from the following detailed description, taken in conjunction with the accompanying drawings, illustrating the principles of the invention by way of example.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1a illustrates a visual display of investment analytics relating to a sample dataset group, in accordance with one embodiment;

FIG. 1b illustrates a method for generating and displaying investment analytics, in accordance with one embodiment;

FIG. 2 illustrates a coded graph of a visual display, in accordance with one embodiment; and

FIG. 3 illustrates a graph of a visual display, wherein the graph is annotated with values, in accordance with one embodiment.

FIGS. 4a-4f illustrate report information relating to a sample dataset group.

FIG. 5 illustrates a system 150 for generating and displaying analytics, in accordance with one embodiment.

### DETAILED DESCRIPTION

The present disclosure relates to novel and advantageous systems and methods for aiding consumers in making investment decisions. In particular, the present disclosure relates to novel and advantageous systems and methods for generating investment analytics by analyzing raw data such as investment metrics and displaying or modeling the investment analytics in an easy-to-understand format. This allows an investor to make decisions based on a multitude of relevant metrics rather than based purely on returns. The systems and methods described herein can be used by investment advisors and investment firms to educate investors, provide financial insights to clients, inform guidance to consumers, and support the financial recommendations they make to their consumers. The systems and methods described herein may be useful to a wide range of individuals. For example, licensed financial advisors or registered investment advisors may use the systems and methods provided herein to advise their clients and/or to select investments.

Generally, many other investment-related, decision-making bodies may find the systems and methods disclosed herein useful. The systems and methods may be used by fund managers to aid in their stock or other investment selection pursuant to the investment funds they manage. The systems and methods may further be used by Chief Investment Offices and other due diligence entities of large institutions, such as brokerage firms, as they seek to limit or allow fund managers onto their platforms. The systems and methods may also be useful to Corporations and Foundations to help guide their in-house analysts' decisions about how to invest corporate or foundation assets. Additionally, the systems and methods would support the due diligence process of any 401k or ERISA retirement plan administrator seeking to fulfill fiduciary obligations to employees and other retirement plan participants.

More broadly, systems and methods described herein may provide a display of comparative data. The display may be visual, tactile, audible, or a combination thereof. In various embodiments, systems and methods described herein analyze metrics and present the resultant analytics in an easy-to-understand manner. Systems and methods described herein can be used to provide a display, such as visual, tactile, audible, or a combination thereof, of any suitable comparative data. In a specific embodiment, systems and methods described herein analyze investment metrics and present the resultant analytics to an individual in a visual and easy-to-understand manner to allow that individual to make an informed investment decision.

In one embodiment, systems and methods described herein may be displayed as a grid or matrix comprised of a plurality of squares across a plurality of quadrants, each square being differently labelled for an assigned value. For example, the grid or matrix may comprise 16 squares across four quadrants, with each square being differently coded with eight colors of assigned value, wherein each color assignment indicates a certain aggregated value of risk and return versus a benchmark. Further, the squares may alternately be shaded with multi-variant color waves to indicate severity of dispersion. Exemplary methods and systems for assigning value are further described herein.

In some embodiments, data points may be grouped into datasets wherein each dataset is attributable to an individual investment or to an investment fund, or fund manager. The systems and methods disclosed herein may be used to analyze multiple points of statistical data based upon relative positioning of the data points in comparison to a benchmark and versus a peer group, in one embodiment. This may be thought of as comparing the data points of datasets against a benchmark and ranking the data points, and the datasets, against peers. As is discussed more fully below, while ranking is done according to metrics described herein, sorting may be done on any metric or combination of metrics and will not affect the ranking. For example, the datasets may be sorted based on a specific data point, such as Risk/Return values or Sharpe Rations, but the ranking will reflect the values of each data point for which a value was given. More generally, ranking reflects the overall performance of each dataset.

In one embodiment, an analysis and visual display tool for comparative data is provided. It analyzes, ranks, and visually displays quantitative and comparative analytic data. In an investment tool embodiment, this may be done relative to, for example, risk/return and up/down capture ratios. In some embodiments, the comparisons are done versus a selected benchmark.

The systems and methods may be used to convert one or more collections of statistical data into a simple, easily-understandable, visually-coded, for example color-coded, table. The visually-coded table illustrates and ranks dataset performance versus a peer group, and in comparison to a shared benchmark. The methods and systems disclosed herein thus may be used to analyze and compare data, for example, investment fund manager data, over a long period of time to set forth which investment fund managers consistently deliver more or less return and/or more or less risk than their peers and/or than the shared relative benchmark in a simple and easy-to-understand display.

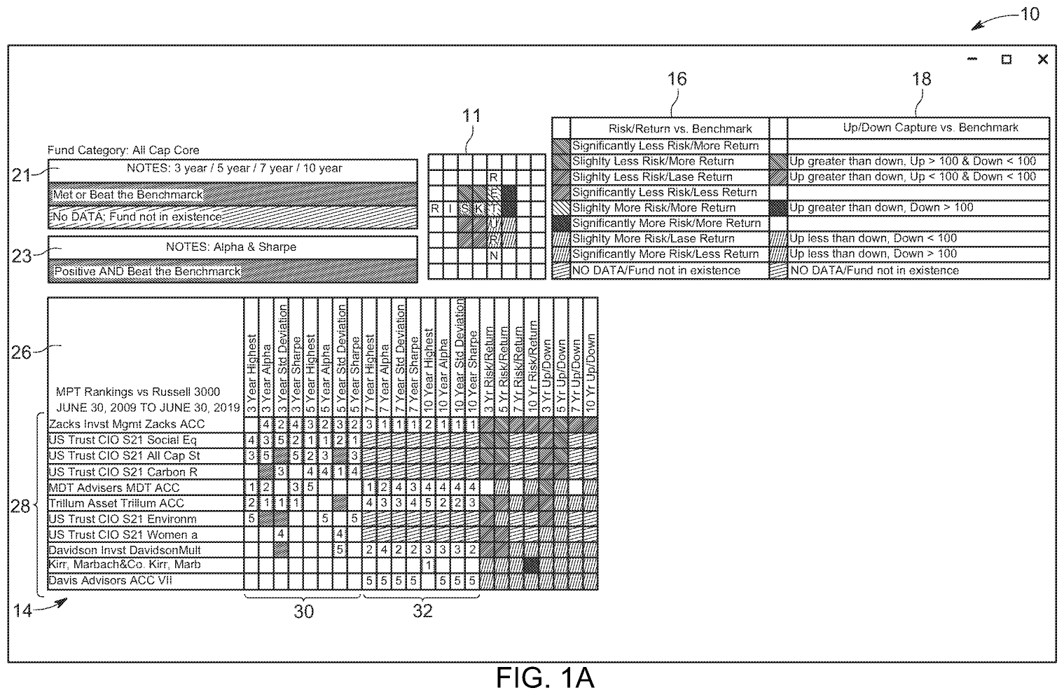

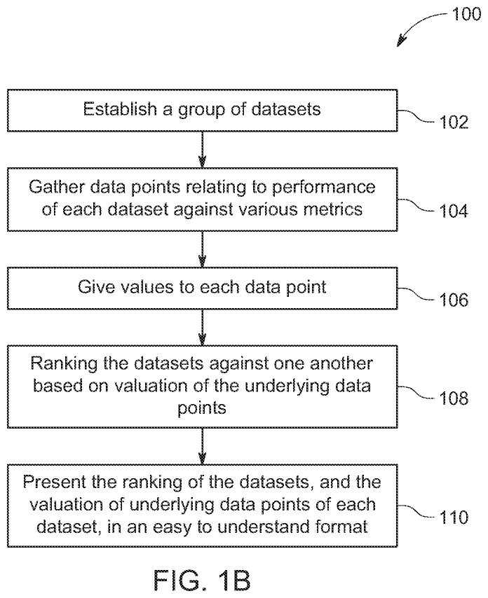

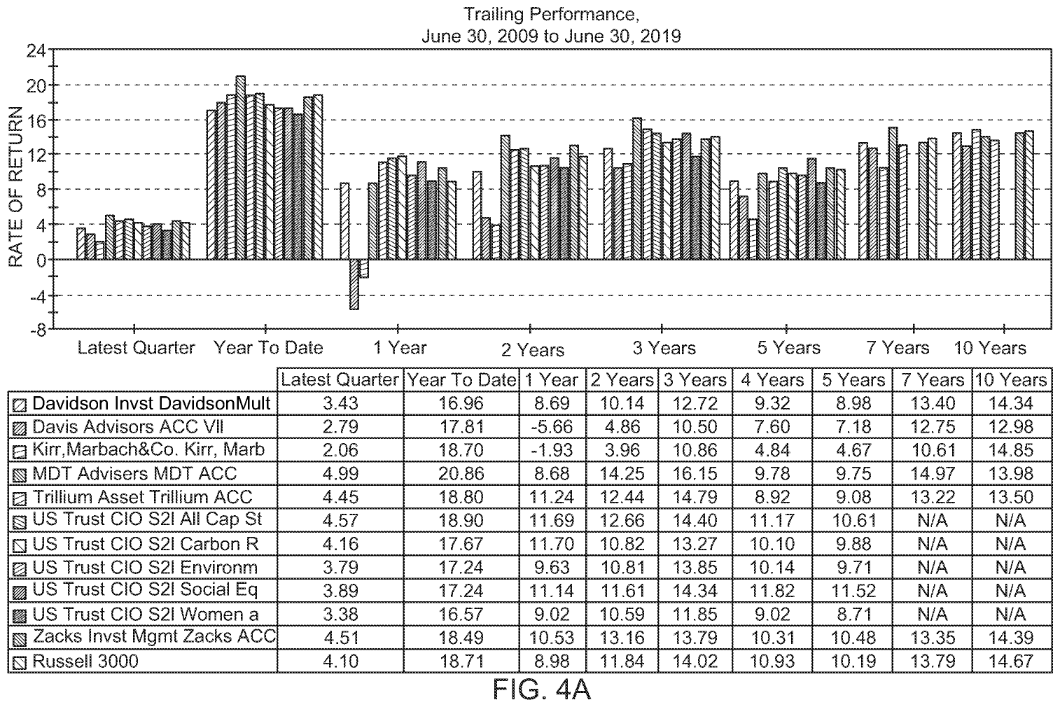

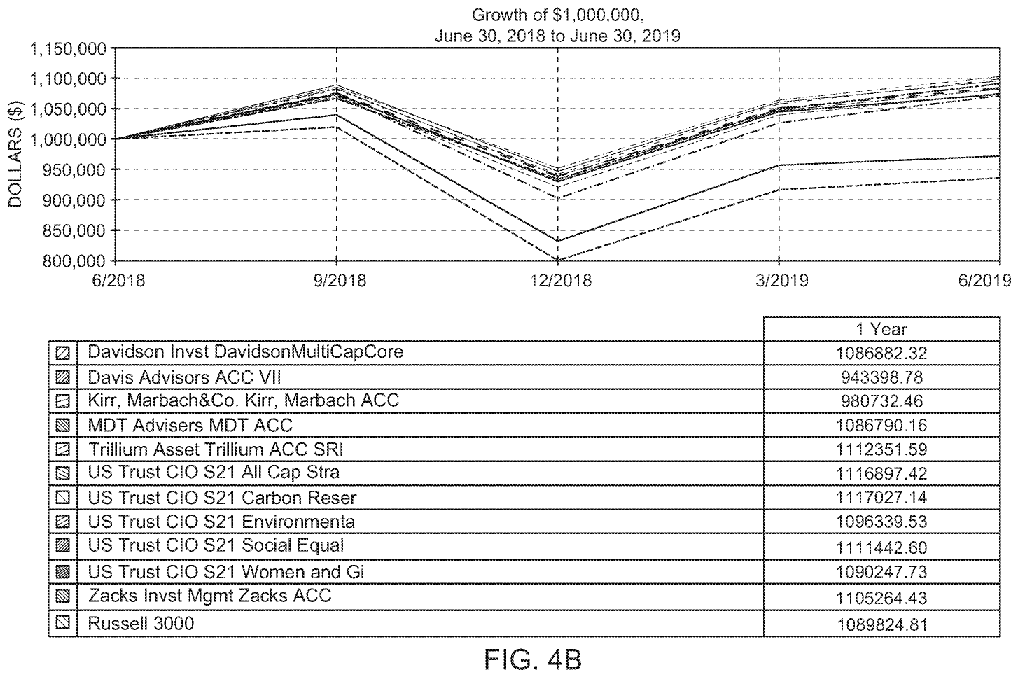

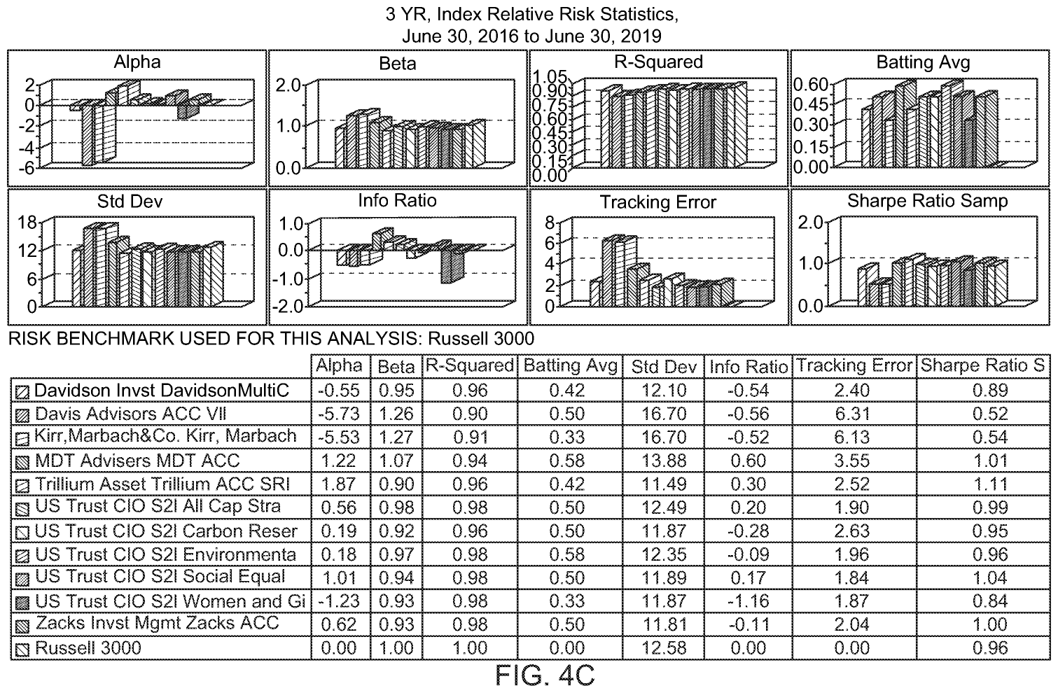

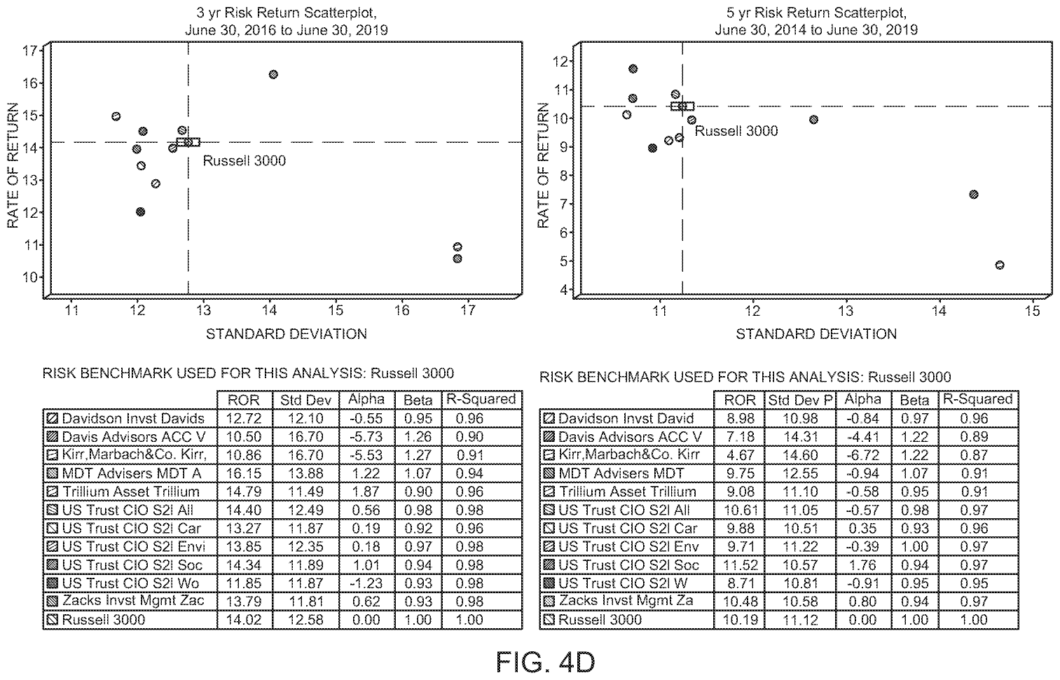

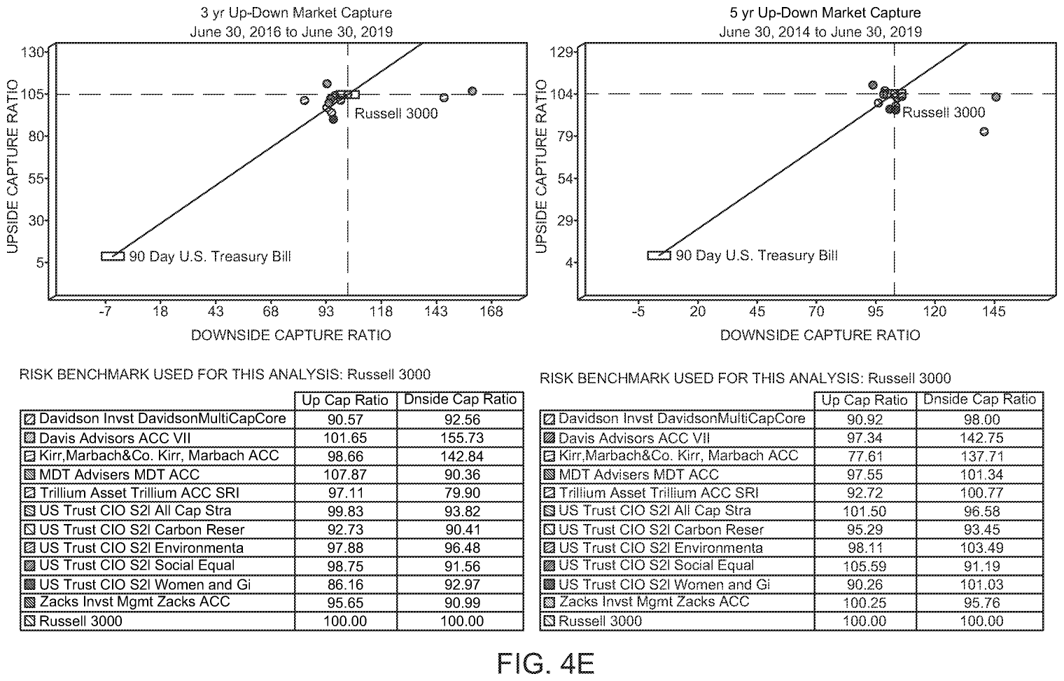

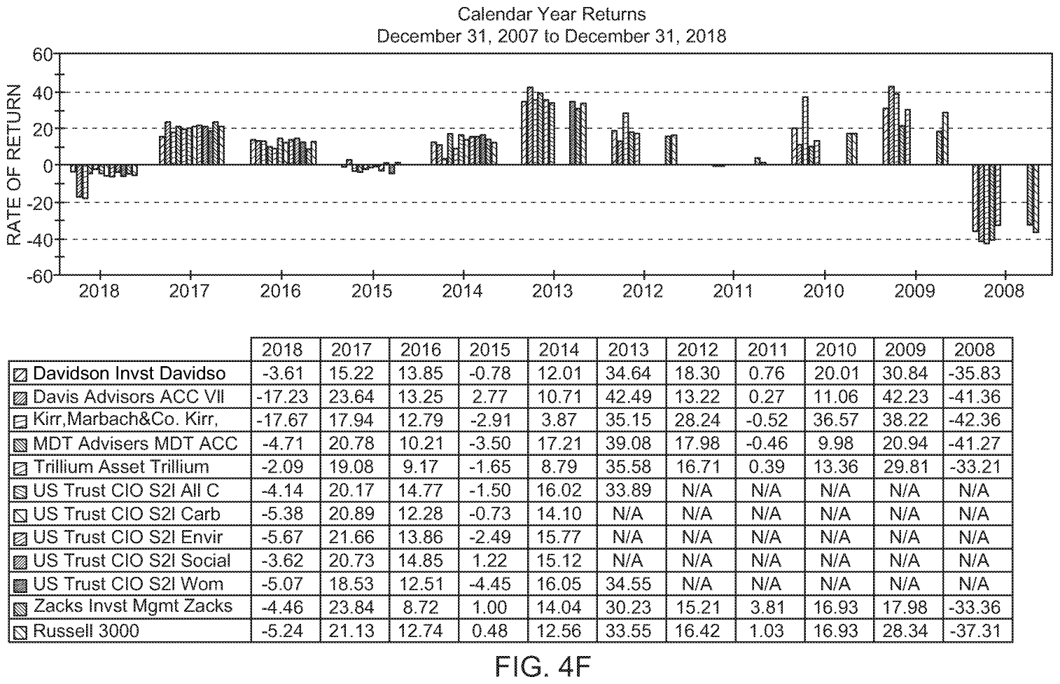

Figure la illustrates a visual display of investment analytics relating to a sample dataset group, in accordance with one embodiment. As shown, Figure la illustrates an embodiment comprising a visual display 10 of investment metrics with a resultant ranking of investment fund managers. The investment metrics are considered the data points, the data points associated with each investment fund manager are considered a dataset (each investment fund manager thus being referred to as a dataset), and the investment fund managers together are considered a dataset group. In some embodiments, the investment metrics, or data, may be culled from a report, described more fully below. The report used for investment metrics for the visual display 10 of FIG. 1a is presented in FIGS. 4-18.

As shown, the visual display illustrates relative performance of several investment fund managers based on a variety of metrics. The metrics used for performing the analysis may vary and may include any metrics that may be useful to a financial analyst, financial advisor, or registered investment advisor. For example, these factors may include risk/return metrics, up/down capture ratios, alpha, beta, R-squared, batting average, information ratio, Sharpe ratio, Treynor ratio, multi-year data trends versus a benchmark, fund performance versus a peer group, and others.

In the embodiment shown in FIG. 1a, the metrics driving the analysis comprise (1) risk/return metrics, (2) up/down capture ratios, (3) multi-year data trends versus a benchmark, and (4) fund performance versus a peer group. The multi-year data trends may be, for example, 1 year/3 year/5 year/and 7 year measurements of Highest, Alpha, Sharpe, and Standard Deviation. In other embodiments, other metrics or other time elements may be used as data points. The visual display illustrates relative out-performance and underperformance of each investment fund manager versus the shared benchmark. It is to be appreciated that while the analysis is done according to these metrics to result in a visual ranking (discussed more fully below), the investment fund managers may be sorted against any metric and the ranking will not be effected.

The metrics may be assessed against performance of other fund managers and against a benchmark. The benchmark used may depend on the investment fund managers being assessed. For example, the benchmark may be the S&P 500 for United States investment fund managers. Any suitable benchmark may be used including, for example, the Russell 3000 for all-cap US equity managers, the Russell 2000 for small-cap US equity managers, a blended index for multi-strategy managers, the MSCI World Index for global equity managers, the MSCI EAFE for international equity investment funds or managers, the MSCI EM index for emerging markets equity managers, the Barclays Capital Aggregate Bond Index for bond fund managers, and so on.

In one embodiment, the system visually displays the analytics, for example via a hierarchical grid format. The display may include a graph illustrating the relative positioning of data points (see graph 11 in FIG. 1a) and a table (see table 14 of FIG. 1a) setting forth the data from the graph, as well as other analytics, and displaying performance of each dataset versus peer datasets. The system may assign value to each data point and rank each dataset based on the values associated with each data point within the dataset. Values may be assigned in different manners depending on the type of data. Colors may be assigned to each data point based on the value associated with the data point. The ranked datasets may be displayed, as shown in table 14 of FIG. 1a, to give a visual indicator of performance that is more or less desirable versus the benchmark and versus the peer group.

FIG. 1b illustrates a method 100 for generating and displaying analytics, in accordance with one embodiment. At a basic level, and in accordance with one embodiment, the method comprises (1) establishing a group of datasets, (2) gathering data points relating to performance of each dataset against various metrics in view of a benchmark, (3) giving a value to each data point, (4) ranking the overall performance of each dataset on the valuation of the data points, and (5) presenting the ranking in a easily-understandable format. Each of these steps is discussed below.

Step 1, shown at 102, relates to establishing a group of datasets. In an embodiment relating to investments, this may comprise establishing a group of investment fund managers.

Step 2, shown at 104, relates to gathering data points relating to performance of each dataset against various metrics. This may comprise gathering data points relating to performance of each dataset, for example investment fund managers, against various metrics in view of a benchmark, for example the S&P 500. These data points may be gathered from any suitable source. In one embodiment, the raw data may be aggregated from Zephyr Portfolio Analytics—Informa Financial Intelligence. Systems and methods described herein may be based on reports for, for example, International Equities, US Large Cap Growth or Value Equities, Smallcap or Midcap equities, REITs, Fixed Income, Commodities, and so on. It is to be appreciated that fund manager performance data is audited by independent accounting firms and then publicly disclosed on manager websites, normally on a monthly or quarterly basis. That data may be gathered and aggregated to serve as statistical data points for analysis by the disclosed system and method. Each data point relating to a specific investment fund manager may be aggregated to form a dataset relating to that investment fund manager.

Step 3, shown at 106, involves assigning values to each data point. Giving values to each data point may involve different methodologies depending on the type of data. For example, in an investment embodiment, the methodology used to assign value to each of (1) risk/return metrics, (2) up/down capture ratios, and (3) multi-year data trends may differ.

For risk/return metrics, the data points may be plotted on a graph and a value given to each data point based on its position on the graph. This is described more fully below in discussion of graph 11.

For up/down capture ratios, the number of the up and down for each dataset relative a benchmark may be used and those numbers input to an algorithm to output a value. This is described more fully below in discussion of key 18 of FIG. 1a.

For multi-year data trends, the data points may be compared to a benchmark and designated as meeting or exceeding the benchmark or falling below the benchmark.

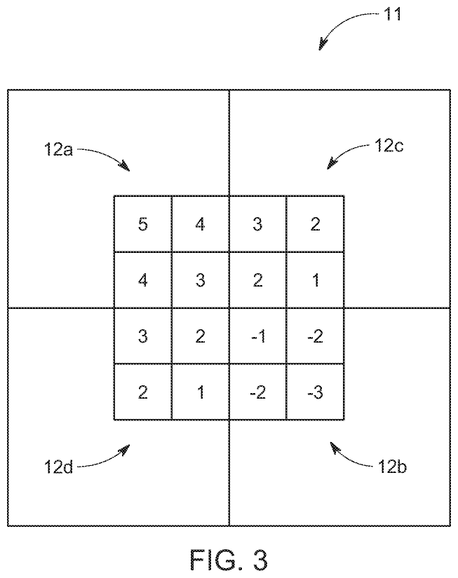

Step 4, shown at 108, involves ranking the datasets against one another based on valuation of the underlying data points. The ranking may be driven by an underlying numeric assignment (see, for example, FIG. 3). In an investment embodiment, the underlying numeric assignment may be driven by 3/5/7/10 year up/down and risk/return plots.

At Step 5, shown at 110, the ranking of the datasets, and the valuation of underlying data points for each dataset, is presented in an easy-to-understand format. In an investment embodiment, this involves presenting the ranking of investment fund managers and the valuation of risk/return metrics, up/down capture ratios, and multi-year data trends. This may be done in table 14 of FIG. 1a.

FIGS. 1a, 2, and 3 illustrate aspects of the visual display for presenting the analyzed comparative data. The visual display 10 displays a plurality of metrics. In one embodiment, these comprise:
Performance versus benchmark for statistical values such as alpha, sharpe ratio, standard deviation, highest return, and the like;
Numerical information relative to the ranking of funds versus the benchmark;
A color-coded valuation of risk/return;
A color-coded valuation of up/down capture; and
A top-down ranking of each fund relative to its peer group based upon the aggregate value of out-performance or underperformance.

In the embodiment shown in FIG. 1a, the visual display 10 includes two analytics displays 11, 14 and three keys 16, 18, 21, and 23. The analytics displays 11, 14 comprise a graph 11 and a table 14.

The table 14 illustrates data that is used in the analytics and displays the ranking resulting from comparison of the datasets. The table 14 illustrates the category being ranked, for example investment fund managers, in the rankings column 26. In some embodiments, the ordering of the investment fund managers in table 14 corresponds with their rank, with the best being at the top of the table and the worst being at the bottom of the table. The table 14 may include a statistical values portion 30 and an analytics portion 32. The information in the statistical values portion 30 and the analytics portion 32 lead to the rankings in the ranking column 26. Key 21 and 23 associate the visual indicators used in the statistical values portion 30 with a valuation. Keys 16 and 18 associate the visual indicators used in the analytics portion 32 with a valuation.

In some embodiments, the table 14 may illustrate the data using a basis of the sort that does not correspond to the underlying ranking. This will present the data in a different manner but will not impact the underlying ranking and values associated with the data.

The statistical values portion 30 relates to performance versus benchmark for statistical values such as alpha, sharpe ratio, standard deviation, and the like. These values may be color-coded to communicate simply, did the investment fund manager beat the benchmark (yes or no), and/or did the investment fund manager perform notably better than the peer group. Numeric values may be assigned to notate rank order of funds as an additional point of interest.

The analytics portion 32 displays the value of Risk/Return versus benchmark data points and Up/Down Capture versus benchmark data points. These may generally be color-coded to reflect, for example, Best, Good, Medium (including, for example, Medium-Less Risk and Medium-More Risk), Bad, and Worst. For an investment embodiment, Good generally indicates less risk and more return, Medium generally indicates less risk and less return or more risk and more return, and Bad generally indicates more risk and less return. Best generally indicates the most return for the least risk and Worst generally indicates the most risk for the least return. In the financial industry, this is known as risk-adjusted return. Among other things, the systems and methods described herein provide a display showing a multi-data point aggregate of the risk-adjusted return.

The comparative ranked data may thus be displayed in a visual framework which gives a visual indicator of performance that is more or less desirable versus the benchmark and versus the peer group. This visual indicator may be, for example, color-coding.

### Risk/Return Versus Benchmark

The graph 11 may be used in an investment embodiment to illustrate relative performance of investment fund managers by evaluating Risk/Return versus a benchmark, as described more fully below. Visual indicators are provided on the graph for illustrating valuation of each data point. In other embodiments, the graph may not be coded and reading of the graph may be based entirely on placement of data points on the graph.

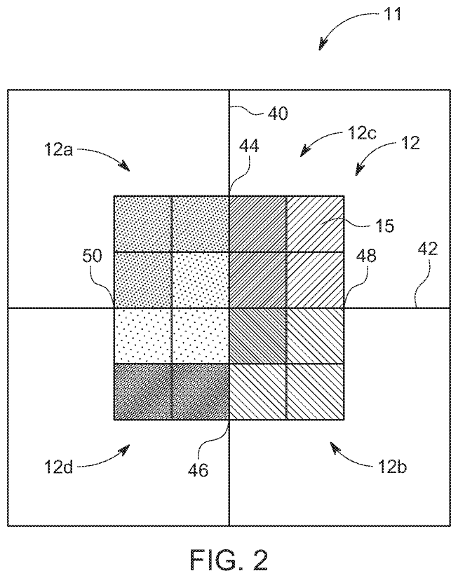

As shown in FIG. 2, the graph 11 may include four grids 12, each of the four grids being divided into subsections 15, here four quadrants, each subsection being assigned a value (described more fully with respect to FIG. 3). The first key 16, shown in FIG. 1a, associates the visual indicators used in the graph 11 with a best/good/medium/bad/worst valuation. In an investment embodiment, the valuation may be:
Dark Green—(Best) Significantly Less Risk and More Return
Light Green—(Good) Slightly Less Risk and More Return
Light Yellow—(Better Medium—Less Risk) Slightly Less Return and Less Risk
Dark Yellow—(Medium—Less Risk) Significantly Less Return and Less Risk
Light Pink—(Better Medium—More Risk) Slightly More Risk and More Return
Dark Pink—(Medium—More Risk) Significantly More Risk and More Return
Light Red—(Bad) Slightly Less Return and More Risk
Dark Red—(Worst) Significantly Less Return and More Risk
   It is to be appreciated that while the valuation as shown in Figure la and explained above is associated with colors as visual indicators, the valuation may otherwise be associated with other visual indicators, for example dots, hashing, or shading, such as shown in FIG. 2. The variations may also be associated with coding systems such as Braille or other tactile or raised-systems for use by individuals who are visually impaired.

In some embodiments, the graph thus is a 16× graph comprising four grids, each divided into four quadrants. To further develop the 16× graph, each color may include shade/tint variations on the color. For example, the green may be shade/tint variations on green—from light green to dark green—to indicate more or less favorability of risk/return. Such variation may be done to any or all colors used in the color-coding, such as red, pink, yellow, or other. The colors thus may pull gradient shades/tints that may be used to further subdivide the graph, for example from 16 subsections into 64 divisions, for example. This creates further dispersion between the variation on “good” vs. “best,” for example within green, or “bad” vs. “worst,” for example within red, and the relative risk/return may additionally variate within the yellow and pink to indicate risk/return favorability.

Returning to FIG. 2, the graph 11 has a vertical axis 40 and a horizontal axis 42. In an investment embodiment, the vertical axis may be return while the horizontal axis may be risk. In other embodiments, and for analysis of other data, the axes may correlate to other metrics. The origin point (0, 0) is at the center of the graph 11. As previously described, the graph may include four grids 12, each of the four grids 12 being divided into four quadrants 15. It is to be appreciated that the grids may be divided into more or fewer subsections and that 4 quadrants is exemplary only. The grids range between a highest value 44 and lowest value 46 on the vertical axis 40 and a highest value 48 and lowest value 50 on the horizontal axis. The numbers of these points 44, 46, 48, and 50 is determined based on the data being evaluated. The greatest absolute value of the risk/return numbers being evaluated is used to set value of the points 44, 46, 48, and 50. In one embodiment, the greatest value of Risk determines the value of points 50 and 48 and the greatest value of Return determines the value of points 46 and 44.

After the grids are established between the origin point and the points 44, 46 on the vertical axis and the points 48, 50 on the horizontal axis, the grids 12 are divided into quadrants 15. In the embodiment shown, the grids 12 are of equal size to one another and the quadrants 15 are of equal size to one another. In other embodiments, there may be size variation between the grids and/or between the quadrants. Visual indicators, such as colors, may be placed in each of the quadrants 15 to indicate performance of data points in those quadrants.

In the investment world, greater return for the same measure of risk is generally more preferable, and less return for the same measure of risk is less preferable. Additionally, less risk for the same measure of return is more preferable and more risk for the same measure of return is less preferable. Some of these are additive when existing together: less risk plus increased return (versus a benchmark) is most preferable and less return plus increased risk (versus a benchmark) is least preferable.

In accordance with some embodiments, the systems and methods disclosed herein translate these preferences into color (or other visual, tactile, or audible indicator) (see graph 11 of FIG. 1a), assign those colors to multi-year manager performance metrics, and then visually and quantitatively rank datasets—for example, investment fund managers—against one another (see table 14 of FIG. 1a). Coding, such as color-coding black, may also be used to notate that there is no data or that the relevant fund manager was not in existence.

The quadrants in the upper left grid 12a are coded Best and Good. In general, these are considered good valuations. The quadrants in the lower right grid 12b are coded Bad and Worst. In general, these are considered bad valuations. The quadrants in the upper right grid 12c are coded Better Medium—More Risk and Medium—More Risk; these may be considered more risky medium. The quadrants in the lower left grid 12d are coded Better Medium—Less Risk and Medium—Less Risk; these may be considered less risky medium. The valuations of the upper right grid 12c (more risky medium) and the lower left grid 12d (less risky medium) are not generally considered bad or good but are relatively bad or good depending on the risk tolerance of an investor.

The coordinates for each data point (3, 5, 7, 10 year risk/return) are plotted on the graph 11. The data point is then assigned the value/color associated with the quadrant in which the data point lands. If a data point lands directly on the delineating line between two quadrants, the data point is rounded up to the better quadrant. If a dataset has no information for a specific data point, that data point is assigned a neutral value of zero (0).

Returning to FIG. 1a, key 16 provides guidance for interpreting the visual indicators of the quadrants 15. In some embodiments, each quadrant may always have the same visual indicator, regardless of the numbers associated with the vertical and horizontal axes at least because the data is being ranked relative to other performers (thus one investment compared to another investment or one investment fund manager compared to another investment fund manager) rather than against a numeric value. In the embodiment of Figure la, the good quadrants in the upper left grid 12a may be shades of green, the bad quadrants in the lower right grid 12b may be shades of red, the more risky medium quadrants in the upper right grid 12c may be shades of pink, and the less risky medium quadrants in the lower left grid 12d may be shades of yellow. In the embodiment of FIG. 2, different types of dots and hashing are used to code the quadrants 12. In other embodiments, any other suitable visual indicators may be used to code the quadrants. In yet other embodiments, the graph may not be coded and reading of the graph may be based entirely on placement of data points on the graph.

FIG. 3 illustrates a graph 11 wherein the graph is annotated with values, in accordance with one embodiment. More specifically, FIG. 3 illustrates an embodiment where a numeric value is associated with each quadrant. The numeric value in each quadrant is not based on the numbers associated with the vertical and horizontal axes of the graph. The numeric value in each quadrant is based on the ranking of the quadrant relative to other quadrants.

As previously described, the graph 11 may include four grids 12, each of those being divided into four quadrants 15, each quadrant being assigned a value. The values are a ranking and, in the embodiment shown, go from −3 to +5. This scale indicates relative desirability of relative performance of risk/return metrics. Specifically, each unit of risk or return involves a trade-off in relative value which pushes the ranking of a fund manager up or down.

### Up/Down Capture Versus Benchmark

Returning to FIG. 1a, the key 18 is used to illustrate the relative performance of each dataset in Up/Down Capture Ratios versus a benchmark. A standard benchmark for up/down capture ratio in investments is 100 percent, represented by “100”. An analysis of that ratio may look at the Up Cap Ratio number versus the Down Cap Ratio number, the Up Cap Ratio number against 100 (for example, is the Up Cap Ratio number more than 100), the Down Cap Ratio number against 100 (for example, is the Down Cap Ratio number less than 100, and/or the delta of the Up Cap Ratio number against 100 versus the Down Cap Ratio number against 100. The algorithm used to rank the performance of each dataset uses some or all of these numbers and gives a value to the result according to the following categories:
(Best) Up greater than Down; Up>100 & Down<100
(Good) Up greater than Down; Up<100 & Down<100
(Medium) Up greater than Down; Down>100
(Bad) Up less than Down; Down<100
(Worst) Up less than Down; Down>100

Visual indicators are assigned to each value. For example, in the embodiment of FIG. 1a, best is color-coded with green, good is color-coded with yellow, medium is color-coded with pink, bad is color-coded with light red, and worst is color-coded with dark red. Black is used to code that there is no data or that the fund was not in existence. In other embodiments, other colors or other visual indicators may be used.

If a dataset has no information for a specific data point, that data point is assigned a neutral value of zero (0) and may be color-coded with black.

### Multi-Year Data Trends

Returning to FIG. 1a, the keys 21 and 23 are used to illustrate the relative performance of each dataset based on a variety of statistical values—such as alpha, sharpe ratio, standard deviation, and the like. These values may be color-coded to communicate whether the investment fund manager beat the benchmark (yes or no), and/or whether the investment fund manager performed notably better than the peer group.

In the embodiment shown, the key 21 relates to 1 year, 3 year, 5 year, and 7 year Highest and Standard Deviation. In other embodiments, other data may be used including, for example, 10 year data. The data point is colored blue if it met or beat the benchmark and black if there is no data (i.e., the fund was not in existence). The key 23 relates to Alpha and Sharpe. The data point is colored blue if it is positive and beat the benchmark. In other embodiments, other colors or other visual indicators may be used.

In addition to evaluating the data point against a benchmark, it is evaluated against other data points. Specifically, a determination is made about the comparative ranking of the data point in that category versus other data points its peer group. For each category (e.g. 1 year Highest), the data points of each dataset (1:1) are ranked 1, 2, 3, 4 and so forth up to the number of datasets. The data points are then coded with that ranking.

### Ranking

The table 14 takes the data points coded according to tables 16, 18, 21, and 23 and displays them in a manner that ranks the datasets and displays the value of the data points. In the embodiment shown in Figure la, the table 14 sets forth the datasets 28 in rankings column 26. The rankings column 26 displays the datasets 28, here investment fund managers, in order from best to worst (relative to one another) based on the systems and methods described herein.

### Data

The systems and methods provided herein may be used to generate and display analytics for any comparative data. In the main embodiments described herein, the systems and methods used to analyze comparative data relating to investments and to display the resultant analytics. The underlying data may come from any source. For investment embodiments, a useful source is a report from Zephyr Portfolio Analytics—Informa Financial Intelligence. These reports are currently used to illustrate various metrics, with different types of graphs being generated for different types of metrics. A sample report of metrics that may be used in the systems and methods herein is shown in FIGS. 4a-4f.

Accordingly, in some embodiments, systems and methods provided herein analyze comparative returns of selected investment fund managers versus a shared benchmark. The systems and methods may present the analyzed data in a comparative, color-coded peer-ranking to illustrate relative outperformance and under-performance of the assessed investment fund managers. In one embodiment, the system and method assigns colors to multi-year manager performance metrics and then visually and quantitatively ranks the underlying data.

The easy-to-understand graphic visual presentation allows an investor to easily make sound, prudent investment choices driven by a simplified understanding of the underlying data, comparative analytics, and multi-year trends. The systems and methods may be useful for comparing mutual funds, exchange traded funds (ETFs), separately managed accounts (SMAs), unit investment trusts (UITs), alternative investments, individual stocks, closed-end funds, or any fund, account, manager, or trust with single-point or other statistical data attached to it.

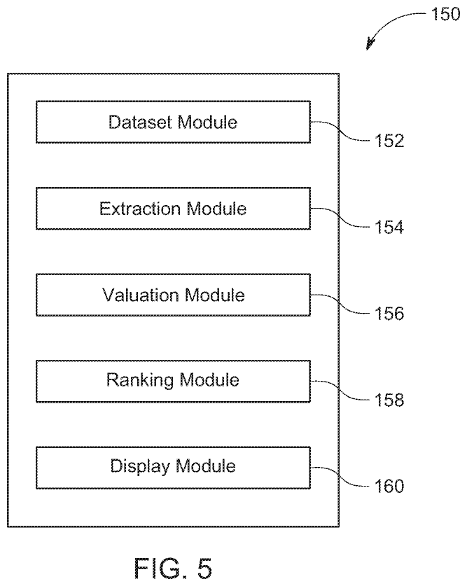

FIG. 5 illustrates a system 150 for generating and displaying analytics, in accordance with one embodiment. The system may include a dataset module 152 for establishing a group of datasets and an extraction module 154 for gathering data points relating to performance of each dataset. The system may further include a valuation module 156 for assigning a value to each data point and a ranking module ranking 158 overall performance of each dataset based on the value of each data point. The system may include a display module 160 for presenting ranking of the datasets in an easily-understandable format.

The dataset module may scrub datasets from a report or may receive input datasets from a user. The datasets may be, for example, investment fund managers. Similarly, the extraction module may scrub data points for each dataset from a report, such as a portfolio analytics report in an embodiment wherein the datasets are investment fund managers.

The valuation module assigns a value to each data point and may do so in any suitable manner. In one embodiment, the valuation module runs the data point through an algorithm. In another embodiment, the valuation module plots the data point on a graph and assigns a value based on the position of the data point on the graph. In yet another embodiment, the valuation module compares the data point to a benchmark and designates the data point as meeting, exceeding, or falling below the benchmark and assigns a value based upon such designation.

The ranking module evaluates the value of each data point in each dataset to develop an overall position of the dataset relative other datasets based on the aggregate value of all data points. This may be done, for example, by using a suitable algorithm that processes each of the data points and datasets.

The display module operates to present the ranking of the datasets in an easily-understandable format. The display module presents a display of comparative data. The display module may display a plurality of metrics. For example, where each dataset is an investment fund, the display module may display at least two of:
performance versus benchmark for data points that are statistical values (such as alpha, sharpe ratio, standard deviation, highest return, and the like);
numerical information relative to the ranking of the investment funds versus a benchmark;
a color-coded valuation of risk/return;
a color-coded valuation of up/down capture; and
a top-down ranking of each investment fund based upon aggregate value of out-performance or underperformance.

In some embodiments, the display module may display the datasets in a hierarchical grid format. For example, the display module may display the datasets in a color-coded hierarchical grid format. The display module may assign a color to data point based on the value associated with the data point and may display that color in a suitable format.

In other embodiments, the systems and methods for generating and displaying analytics may be used to analyze and display other comparative data. For example, it may be used to analyze economic trending, baseball statistics, NBA athlete stats vs. player income and/or criminal activity, national scholastic or student grades vs. test rankings, real estate trends, home prices vs. crime rates, elections or polling data, earnings, credit use, CDC or other population statistics, un/employment data, utilities pricing, and wage trends. In general, it can be used to analyze and display data in any industry where data is aggregated, scored, ranked, evaluated, and used versus a benchmark.

Metrics that may be used with systems and methods described herein include:

Returns-Based Style Analysis: A concept developed by Nobel laureate William Sharpe, returns-based style analysis is a type of multi-factor style analysis in which the multiple factors are the returns of benchmark indexes. It is a method of evaluating a portfolio's style and “determining a fund's exposure to changes in the returns of its benchmark indexes.” A quadratic optimizer is used to determine the minimum variance between a manager's set of returns and a composite of index returns.

Annualized Performance: The returns are displayed for each of the time periods (as available) on an annualized or annual equivalent basis. This chart displays the returns of the Manager's performance composite on both a “gross” and “net” of fees basis. Gross manager returns are calculated before the deduction of the Consults or investment management fee. Net returns are gross results reduced by the maximum Consults fee. The chart also contains the Style Index provided for performance comparisons.

Standard Deviation: Measure of the amount of risk present in a portfolio. Standard Deviation gives an indication of the range of returns to be expected in an average year. For example, if a portfolio has an average annual return of 10% and a Standard Deviation of 6%, ⅔ of the time, returns were between 4% and 16% in a year. Standard Deviation is a measure of the dispersion (variability) of a portfolio's quarterly rates of return around its mean rate for the period. Generally, the higher the Standard Deviation, the higher the variability or risk.

Downside Risk: Downside risk identifies volatility only on the down (negative) side. In the analysis, extreme low returns are considered risky and high returns, no matter how extreme, are deemed to be desirable, as compared to standard deviation which attributes volatility in either direction to risk. Therefore, a high (or low) downside risk number relative to a benchmark indicates more (less) downside volatility.

Alpha: Total Market Line Alpha measures the investment manager's risk adjusted excess return over the style index. In calculating the Market Line Alpha, Standard Deviation (total risk) is used as the risk measure. Alpha may be positive or negative. A positive Alpha indicates the risk adjusted performance is above the style index. Graphically, Alpha is the vertical distance between the portfolio composite and the Market Line.

Beta: Beta is used to measure market risk. Beta defines the average relationship, over time, of the rate of return of a portfolio or security to the rate of return of the style index. A manager that is equally as volatile as the market index has a beta of 1.0, a manager half as volatile as the market index has a beta of 0.5. Managers with a beta higher that 1.0, such as 1.2 are more volatile than the market index.

R-Squared: The diversification measure, R2, indicates the percentage of volatility in portfolio returns which can be “explained” by market volatility. The greater the value of R2, the greater the diversification of the portfolio or comparative index. This statistic is derived from the regression equation and indicates the degree to which the observed values of one variable, such as the returns of a managed portfolio, can be explained by, or are associated with the values of another variable, such as a market index. R2 values range from 0.0 to 1.0. A completely diversified manager will be perfectly correlated with the market, for example to the S&P 500, and will have an R2 of 1.0. A non-diversified manager will behave independently of the market and will have an R2 of 0.0. An R2 between 0.9 and 1.0 show the degree of association is very close. An R2 of 0.95, for example, implies that 95% of the fluctuations in a portfolio are explained by fluctuations in the market.

Tracking Error: A measure of how closely a manager's returns track the returns of the Style Index. The tracking error is the annualized standard deviation of the differences between the manager's and the Style Index's quarterly returns. If a manager tracks a style index closely, then tracking error will be low. If a manager tracks a style index perfectly, then tracking error will be zero.

Information Ratio: The information ratio is a measure of value added by the manager. It is the ratio of (annualized) excess return above the style index to (annualized) tracking error. Excess return is calculated by linking the difference of the manager's return for each period minus the style index's return for each period, then annualizing the result.

Capture Ratio—Up-Market: A measure of the portfolio's performance during up markets relative to the market benchmark (S&P 500, for example). The higher the capture ratio, the better the portfolio has performed in a rising market. For example, an Up-Market Capture ratio of 110 indicates that the portfolio captured 110% of the market's performance (the portfolio returns were 10% greater than the market). A negative ratio indicates that the portfolio had negative returns when the market had positive returns.

Capture Ratio—Down Market: A measure of the portfolio's performance during down markets relative to the market benchmark (S&P 500, for example). The lower the capture ratio, the better the portfolio performed in a declining market. For example, a Down-Market Capture ratio of 90 indicates that the portfolio's losses were only 90% of the market's losses when the market was down. A negative ratio indicates the portfolio had positive returns when the market had negative returns. Note: The magnitude of the ratio may be deceiving if the return figures are small. For example, if the market returned −0.1% and the portfolio returned −0.3%, the result is a down market capture ratio of 300.

It is to be appreciated that these metrics are exemplary only and other metrics may be used based on the industry in which the systems and methods are being used. Further, more or fewer metrics may be used. The systems and methods described herein can use any of the above listed metrics, or other metrics, to plot/rank relative desirability of any one or combination of these or other metrics.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, Bluetooth, Wi-Fi (wireless fidelity), etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, software subscriptions, app subscriptions, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A method for generating and displaying analytics:
establishing a group of datasets;
gathering data points relating to performance of each dataset;
assigning a value to each data point;
ranking overall performance of each dataset based on the value of each data point; and
presenting ranking of the datasets in an easily-understandable format.

2. The method of claim 1, wherein presenting ranking of the datasets comprises providing a display of comparative data.

3. The method of claim 1, wherein presenting ranking of the datasets in an easily-understandable format comprises presenting a visual display of the ranking.

4. The method of claim 3, wherein each dataset is attributable to an investment fund, wherein the visual display displays a plurality of metrics, and wherein the plurality of metrics include at least two of:
performance versus benchmark for data points that are statistical values;
numerical information relative to the ranking of the investment funds versus a benchmark;
a color-coded valuation of risk/return;
a color-coded valuation of up/down capture; and
a top-down ranking of each investment fund based upon aggregate value of out-performance or underperformance.

5. The method of claim 3, wherein the visual display comprises a hierarchical grid format.

6. The method of claim 3, wherein the visual display comprises a color-coded format display, wherein colors are assigned to each data point based on the value associated with the data point.

7. The method of claim 1, wherein presenting ranking of the datasets in an easily-understandable format comprises presenting a tactile or audible display of the ranking.

8. The method of claim 1, wherein ranking the overall performance of each dataset ranks the performance of each dataset versus a peer group and in comparison to a shared benchmark.

9. The method of claim 8, wherein presenting ranking of the datasets illustrates relative out-performance and underperformance of each dataset against the shared benchmark.

10. The method of claim 1, further comprising sorting the datasets based on the value of a selected data point.

11. The method of claim 10, wherein sorting the datasets does not affect ranking of overall performance of each dataset.

12. The method of claim 1, wherein each dataset is attributable to an individual investment, an investment fund, or a fund manager.

13. The method of claim 12, wherein the data points for each dataset comprise investment metrics.

14. The method of claim 13, wherein the data points include risk/return metrics, up/down capture ratios, and multi-year data trends in view of the benchmark.

15. The method of claim 1, wherein assigning a value to each data point comprises plotting the data point on a graph and assigning a value based on the position of the data point on the graph.

16. The method of claim 1, wherein assigning a value to each data point comprises comparing the data point to a benchmark and designating the data point as meeting, exceeding, or falling below the benchmark.

17. A computer-readable storage medium containing program instructions for a method for generating and displaying analytics, wherein execution of the program instructions by one or more processors of a computer system causes the one or more processors to perform steps comprising:
establishing a group of datasets;
gathering data points relating to performance of each dataset;
assigning a value to each data point;
ranking overall performance of each dataset based on the value of each data point; and
presenting ranking of the datasets in an easily-understandable format.

18. A system for generating and displaying analytics, the system comprising:
a dataset module for establishing a group of datasets;
an extraction module for gathering data points relating to performance of each dataset;
a valuation module for assigning a value to each data point;
a ranking module ranking overall performance of each dataset based on the value of each data point; and
a display module for presenting ranking of the datasets in an easily-understandable format.

19. The system of claim 18, wherein the datasets comprise investment fund managers.

20. The system of claim 19, wherein the extraction module gathers data points from a portfolio analytics report.
